(19) United States
(12) Patent Application Publication
(10) Pub. No.: US 2009/0241939 A1
(43) Pub. Date: Oct. 1, 2009

(54) Solar Receivers with Internal Reflections and Flux-Limiting Patterns of Reflectivity

(76) Inventors: Andrew Heap, Pasadena, CA (US); Steven Schell, Monrovia, CA (US); Seyed A. Ebrahimi-Sabet, Glendale, CA (US); Gregg Luconi, Monrovia, CA (US); Quoc Pham, Los Angeles, CA (US); Adam Azarchs, Pasadena, CA (US); Dan Reznik, New York, NY (US); Porter Arbogast, Pasadena, CA (US); Craig Tyner, Albuquerque, NM (US)

Correspondence Address: MICHAEL BLAINE BROOKS, P.C., P.O. BOX 1630, SIMI VALLEY, CA, 93062-1630, US

(21) Appl. No.: 12/389,833

(22) Filed: Feb. 20, 2009

Related U.S. Application Data
(60) Provisional application No. 61/066,684, filed on Feb. 22, 2008.
(60) Provisional application No. 61/069,807, filed on Mar. 18, 2008.

(51) Int. Cl. F24J 2/06; F24J 2/07; F24J 2/48; F03G 6/06

(52) U.S. Cl. 126/645; 126/680; 126/704; 126/710

(57) ABSTRACT

Solar receivers and particularly to solar receivers having one or more cavities and optionally having absorptivity/reflectivity patterns on surfaces and methods of reflective material application.

### CROSS-REFERENCE TO RELATED APPLICATIONS

This application claims the benefit of U.S. Provisional Patent Application Ser. No. 61/066,684, filed Feb. 22, 2008 and U.S. Provisional Patent Application Ser. No. 61/069,807, filed Mar. 18, 2008, both of which are hereby incorporated by reference in their entirety for all purposes.

### BACKGROUND

1. Field of Endeavor

The invention relates to solar receivers and particularly to solar receivers having zero or more cavities and having optional reflectivity patterns on surfaces.

2. State of the Art

Generally, a solar power plant may include an array of reflective surfaces redirecting the sunlight toward a solar receiver for absorption. In a heliostat arrangement, the reflective surfaces may be disposed in an array and oriented to direct, throughout the course of a day, reflected sunlight to a target region of a solar receiver. A portion of the reflected sunlight is absorbed as heat by a heat transfer fluid (HTF) such as water/steam. The HTF is conveyed to a power block where it is used to drive a steam turbine directly, or indirectly, via heat exchangers, and in turn generate electrical power.

A solar receiver may be constructed having a cavity bound by one or more receiver walls and an aperture. Sunlight reflected by a heliostat array enters the receiver via the aperture. The flux distribution incident upon the receiver walls, i.e., the absorbing surfaces, is generally non-uniform. The nature of this non-uniformity is dependent on many factors, including the heliostat field geometry, sun position, and receiver geometry. An exaggerated amount of non-uniformity can lead to areas of very high flux, or “hot spots” which are above the levels accepted for safe operation and/or thermal stability of absorption surfaces and HTF.

### SUMMARY

Embodiments of the present invention include a solar receiver comprising: a receiver housing comprising a cavity and an incident solar flux receiver comprising a first receiver panel, the first receiver panel comprising a plurality of absorber tubes. In some solar receiver embodiments, the first receiver panel comprises a first internal surface comprising a light reflective region configured to reflect a portion of incident light received via a first housing aperture. In other solar receiver embodiments, the receiver housing comprises two cavities defined by the first housing aperture and a second housing aperture and the incident solar flux receiver, the incident solar flux receiver comprising a second internal surface for receiving incident light via the second housing aperture. In still other solar receiver embodiments, the receiver further comprises a boiler for storing saturated steam and water from the first panel, the boiler comprising a steam separator and a steam conduit; and may further comprise a second panel comprising a plurality of superheated steam tubes for receiving the saturated steam from the boiler.

Some embodiments of the present invention include a cavity receiver where the first receiver panel comprises a first internal surface of the cavity comprising a light reflective material configured to reflect a portion of incident light received via a first housing aperture. The light reflective material may comprise paint, sputtered metals, and/or silicon carbide foam. The light reflective material may be applied in a non-uniform pattern and may be applied according to the teaching of the specification. The light reflective material may be applied in a non-uniform pattern comprising at least one of: pixilation, grayscale pixilation, and a panel array. The light reflective material may be applied based on a known or estimated non-uniform pattern to maintain flux absorptivity below the threshold, e.g., the threshold may be set as a value in a range between 400-600 kW/m².

Process embodiments of the present invention include methods of dispersing incident solar flux within a cavity of a solar receiver comprising: determining a region of a cavity surface of the solar receiver exceeding a threshold of absorbed flux; and applying a reflective medium proximate to the determined region. The application may comprise patterns that are based on, and account for, reflections internal to the receiver cavity, may effectively distribute the solar flux within the cavity to several surfaces, retaining the solar energy within the receiver while ameliorating regions that may otherwise experience excessive levels of absorbed heat. Accordingly, method embodiments of the present invention where walls, e.g., internal walls of a cavity receiver, have surfaces of lineally constant or non-constant reflectivity patterns that may be explicitly applied to redirect incident sunlight to other surfaces so as to control or otherwise attenuate peak fluxes and achieve balanced/efficient flux pattern distributions.

Additional embodiments of the invention include methods of dispersing incident solar flux within a cavity of a solar receiver comprising: determining a region of a cavity surface of the solar receiver exceeding a threshold of absorbed flux; and applying a reflective material proximate to the determined region. The reflective material may be selected from a group consisting of: paint, sputtered metal, and silicon carbide foam. Other embodiments of the invention include methods of dispersing incident solar flux within a cavity of a solar receiver comprising: determining a region of a surface of a cavity wall of the solar receiver exceeding a threshold of absorbed flux; and applying a reflective material proximate to a portion of the cavity wall surface based on the determined region exceeding the threshold. The reflective material may be selected from a group consisting of: paint, sputtered metal, and silicon carbide foam. The step of applying the reflective material further comprises applying the reflective material non-uniformly across a portion of the wall of the receiver. The step of applying the reflective material further comprises applying the reflective material non-uniformly across a portion of the wall of the receiver based on a pattern comprising at least one of: pixilation, grayscale pixilation, and a panel array. The exemplary step of non-uniform application may be based on maintaining flux absorptivity below the threshold, e.g., a value in a range between 400-600 kW/m².

### BRIEF DESCRIPTION OF THE DRAWINGS

Embodiments of the present invention are illustrated by way of example and not limitation in the figures of the accompanying drawings, and in which:

FIG. 1 is a system functional block diagram of a water-steam circulation system for power generation comprising a heliostat array, a receiver, and a power block;

FIG. 2 is an illustration of a general water-steam receiver embodiment of the present invention;

FIG. 3 is an exemplary oval cavity solar receiver embodiment of the present invention;

FIG. 4 is an exemplary deployment of an oval cavity solar receiver embodiment of the present invention;

FIG. 5 is an exemplary side view of the two-cavity solar receiver embodiment of the present invention;

FIG. 6 is an exemplary perspective view of the two-cavity solar receiver embodiment of the present invention;

FIG. 7 is an exemplary side-view (shown schematically) deployment of a two-cavity receiver embodiment of the present invention;

FIG. 8 is a top perspective view of a two-cavity receiver embodiment of the present invention without a housing;

FIG. 9 is a bottom perspective view of a two-cavity receiver embodiment of the present invention without a housing;

FIG. 10 is a top perspective view of a two-cavity receiver embodiment of the present invention within a housing;

FIG. 11 is a bottom perspective view of a two-cavity receiver embodiment of the present invention within a housing;

FIG. 12 is perspective view of an exemplary four-panel receiver for a four-cavity receiver embodiment of the present invention;

FIG. 13 is a perspective view of an exemplary eight-panel receiver for a four-cavity receiver embodiment of the present invention;

FIG. 14 is a top view of an exemplary eight-panel receiver for a four-cavity receiver embodiment of the present invention;

FIG. 15 illustrates levels of heat absorption on a back panel of a solar receiver embodiment of the present invention;

FIGS. 16A and 16B together are a flowchart of a method for computing the reflectivity pattern which limits solar flux to below a threshold value;

FIG. 17 is a example of a reflectivity pattern increased on a receiver surface that limits the peak of absorbed solar flux;

FIG. 18 illustrates levels of heat absorption on a back panel of a solar receiver embodiment of the present invention with the application of reflective material proximate to the surface of the back panel to limit flux peaks;

FIG. 19 illustrates a panel-by-panel embodiment of reflectivity application proximate to the surface of the back panel to limit flux peaks;

FIG. 20 illustrates predicted regions of incident solar flux on a receiver panel having a nominal highly heat absorbent surface;

FIG. 21 illustrates generated values of reflectivity expected to limit the peak flux;

FIG. 22 illustrates expected absorbed flux values within regions of a receiver panel having modified its absorptivity from a nominal highly absorptive level at the surface; and

FIG. 23 illustrates a panel-by-panel or pixel-by-pixel application of levels of reflectivity patterned onto a surface to limit the peak flux.

### DETAILED DESCRIPTION

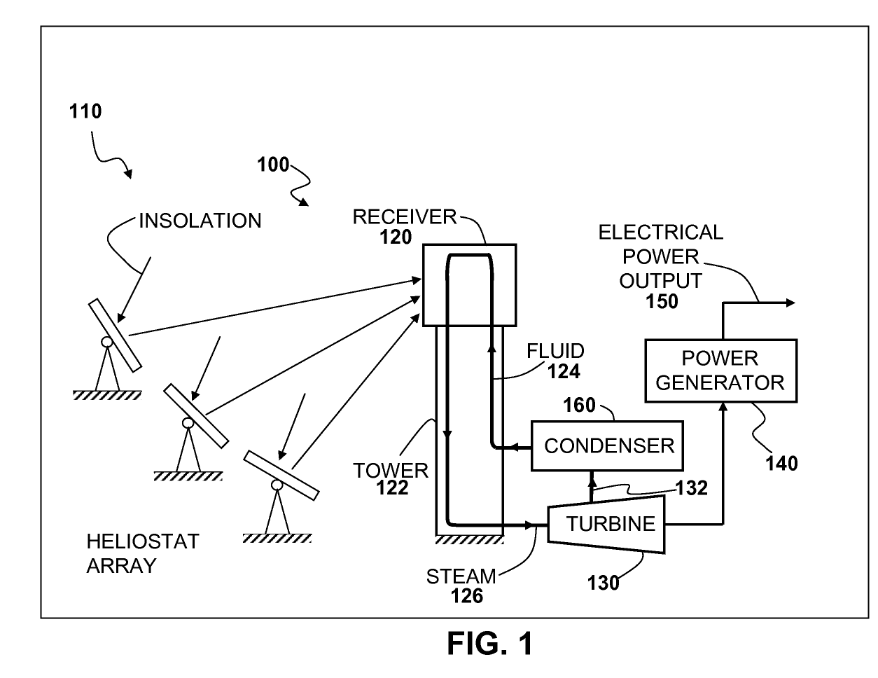

FIG. 1 illustrates generally a solar-based power generating system 100. Sunlight incident onto an exemplary heliostat array of mirrors 110, is reflected toward a solar receiver 120 configured for conversion into heat. The solar receiver 120 may be disposed above ground on a tower 122. For a solar-based power generating system 100 using water, liquid water 124 may be piped to the solar receiver 120 from a reservoir or, as shown in FIG. 1, from a condenser 160 itself receiving the cooling fluid/steam 132 from the turbine 130. The liquid water in the receiver may be boiled to steam as the liquid absorbs heat from the solar receiver 120. The steam 126 may become superheated and may be directed into a steam turbine 130 that may be connected to a power generator 140 that provides an electrical power output 150.

In some embodiments, the steam generator circulation system may be thermally-driven with or without a circulating pump, or once-through with or without superimposed recirculation. Embodiments of the present system embodiments may be employed as water/steam systems having various operating pressures and temperatures: saturated steam, superheated steam, supercritical steam or ultra-critical steam. Other working fluids may include organic or synthetic oils, molten salts, and liquid metals. Various embodiments of the above exemplary receivers may include headers, supply tubes, and tube-header junctions that may be assembled, for example, via rolled tube-to-drum or welded tube-drum connections. For example, a plurality of water wall tubes where subcooled water may be fed through supply lines, also termed down-corners, and water wall supply headers that may be disposed at the gravitational bottom of the water wall tubes, and as the water absorbs heat from the tubes, the water may leave the tubes in a saturated condition. In yet another embodiment, the pressure part tubing could be smooth or ribbed, e.g., rifled. The reservoir of water and steam, also termed a steam drum, may be disposed gravitationally above the water wall tubes, and within the steam drum the separation of water and steam occurs. In some embodiments, the steam drum may be replaced by once-through steam generators, and the steam generators selected may depend on the operating pressure/temperature class or other requirements of the water/steam system. For some receivers, boiler bank tubes may be disposed proximate to the steam drum to recover heat and preheat water being fed to the drum, for example. An optional distribution header is a mud drum. The preheating structure may also be termed an economizer. Some receivers may include an aperture cooler where an economizer or other fluid conduit is disposed proximate to the housing portion bounding the aperture. The separated steam may be fed to a superheater structure where the superheating of steam occurs as the steam absorbs heat from the walls of the superheater structure.

Embodiments of the receiver may include the pressure parts oriented vertically or horizontally, or in other orientations. Accordingly, the superheater structures may be fashioned as portions of receiver walls and locations of superheater structures which may be made up of the front, side, rear, top, or bottom walls of the one or more cavities of the receiver. Superheater sections may be located in front or behind other sections to either protect surfaces by their own heat absorption, or be protected from excessive heat fluxes. Additional structures carrying liquid may be applied to walls of the receiver, particularly not already covered by pressure parts, e.g., not already covered by superheater sections and saturated steam sections, to preheat the feed water being fed to the steam drum. Screen tubes may be used in front of superheaters or other pressure parts to reduce the excessive heat flux to those sections. Desuperheaters may be disposed as intermediate or after a final stage of the superheater sections to control the superheater outlet temperature. In other embodiments for a receiver outputting only saturated steam, the superheater sections may not be present.

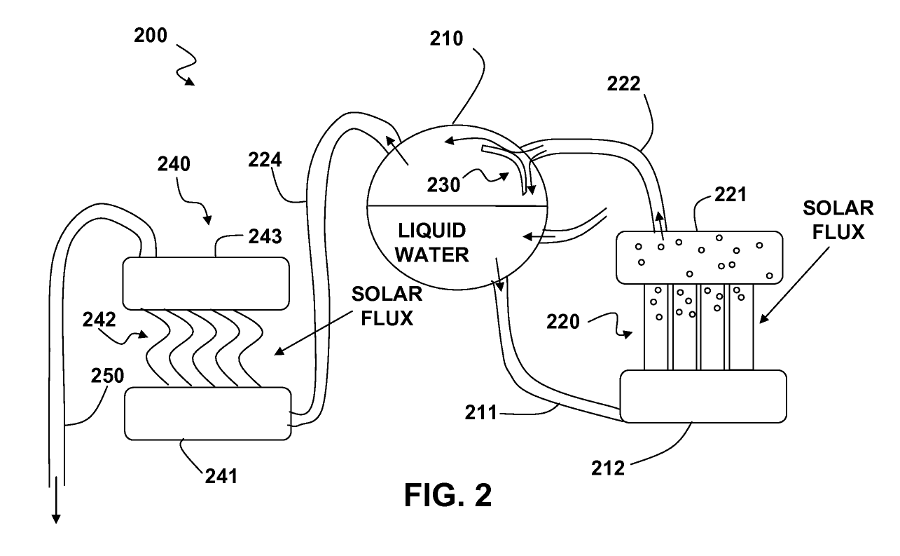

FIG. 2 illustrates a solar receiver subassembly 200 where a heat transfer fluid, such as water in this example, is provided to a reservoir chamber 210. The water fills the lower portion of the cavity and drains via a downspout, or a down-corner 211, into a first header 212. A plurality of conduits 220 provide for the water of the first header 212 to flow into a second header 221. The second header 221 may be positioned gravitationally above the first header 212. The plurality of conduits 220 may transfer heat that may have originated from solar absorption, to the water passing through the plurality of conduits 220 from the first header 212 to the second header 221. Accordingly, the water in the plurality of conduits 220 may become less dense as the water volume partially transitions to steam in flowing from the first header 212 to the second header 221. The second header 221 may comprise a riser 222 or relief tube that conducts the less dense water/steam mixture back to the reservoir cavity 210. The water coming from the second header 221 may be directed to an array of primary and secondary separators 230 to separate the steam from the liquid water and return the water to the low portion of the cavity 210. A superheater inlet 224 allows for a contained venting of the steam to a first header 241 of a superheater assembly 240. The steam may be conducted via a plurality of conduits 242 that may transfer absorbed heat, to pass steam through the plurality of conduits 242 from the first header 241 of the superheater to a second superheater header 243. The steam arriving at the second superheater header 243 may be superheated steam and conveyed to a steam turbine 130 (FIG. 1) via a high pressure tube 250.

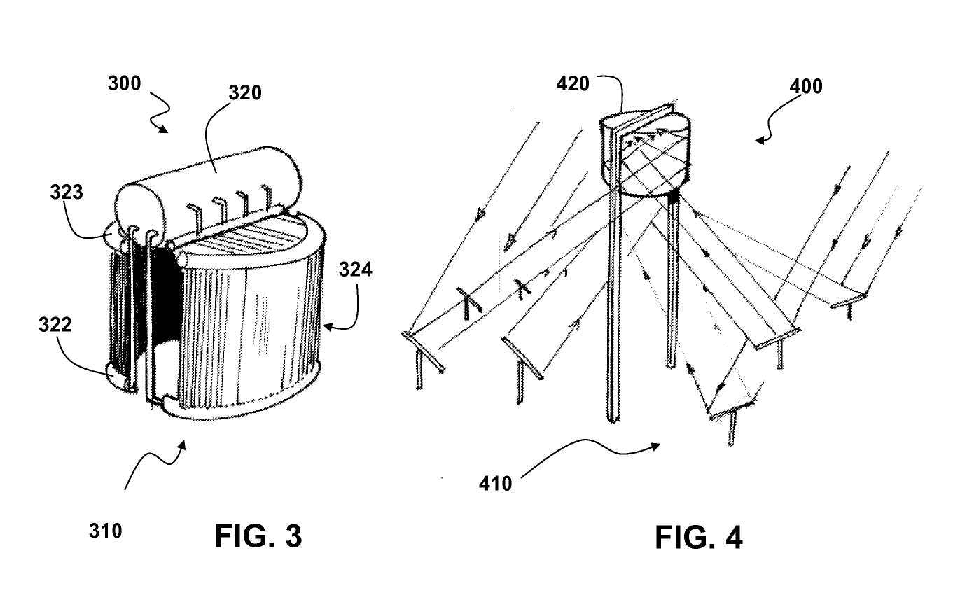

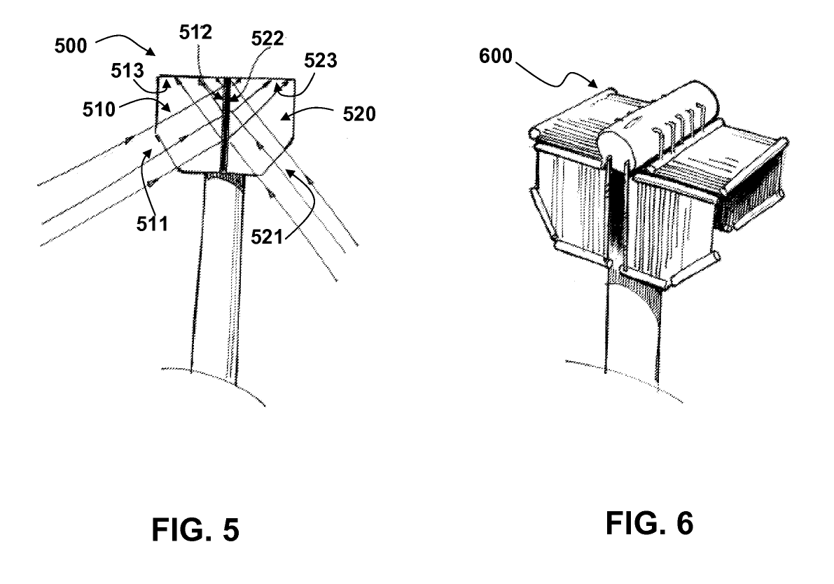

FIG. 3 illustrates a cavity solar receiver subassembly fashioned with an oval, or cylindrical footprint 300 closed at the top and having an opening 310, or aperture, at the opposite end. The boiling headers 322, 323 and plurality of conduits 324 between them may be fashioned about the perimeter wall of the solar receiver 300. The superheater headers and plurality of conduits between them may also be fashioned about the perimeter wall and may comprise a portion of the structure closing the top end of the solar receiver along with the steam drum 320. FIG. 4 illustrates a system 400 comprising an array of reflectors 410 functioning as a heliostat array and reflecting sunlight into an inner surface of the tower-mounted solar receiver 420 via a receiver aperture opening downward in this embodiment. The solar receiver is shown oriented gravitationally vertical along its principle axis but may be canted at some angle, to accommodate an array of heliostats which is not centered at the tower, for example. Exemplary light rays are shown reflecting from wall surface to wall surface within the cavity of the exemplary receiver

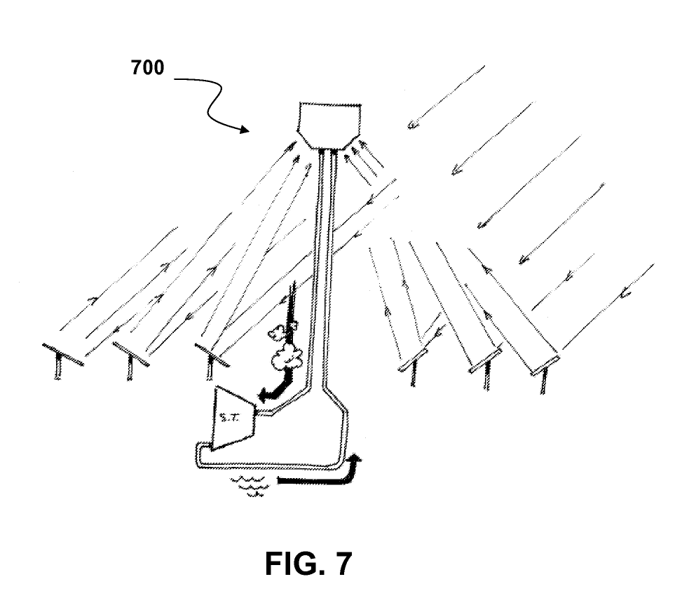

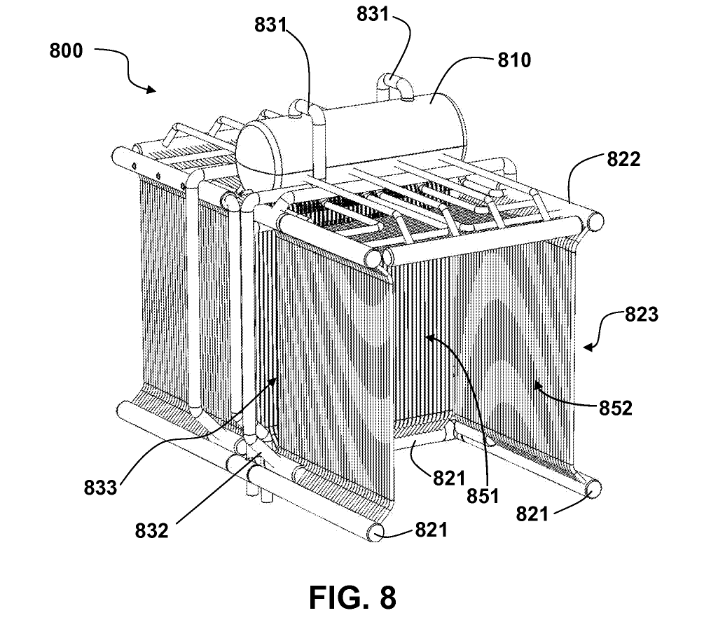

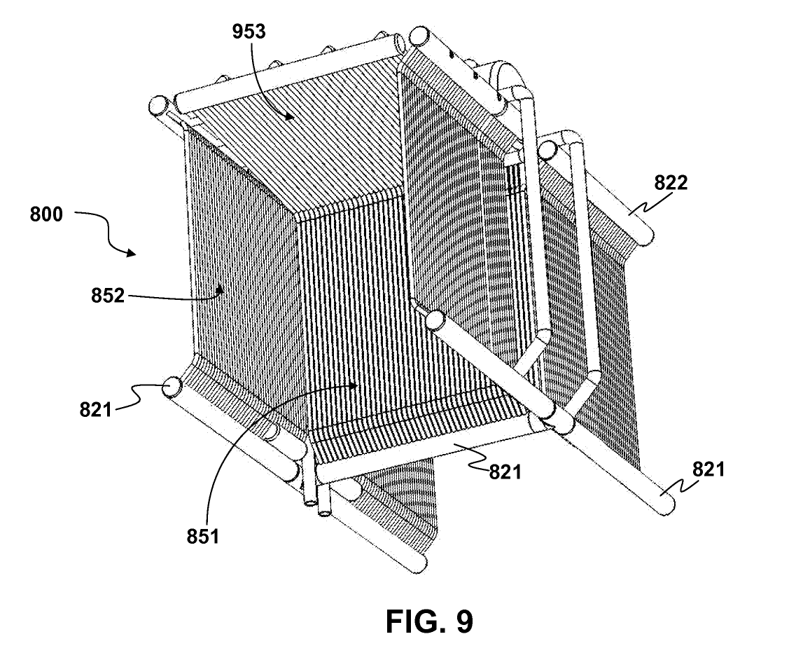

Embodiments of the solar receiver may comprise two or more cavities, each with its own opening, or aperture configured to admit light into a cavity defined by the walls of the receiver housing. FIG. 5 illustrates a cross-section of a tower-mounted cavity solar receiver 500 subassembly where a first cavity 510 has a first aperture 511 and a second cavity 520 has a second aperture 521 and the first cavity shares a common wall with the second cavity. Accordingly, in some embodiments of a two opposite cavity receiver, the rear wall may be a common wall, i.e., illuminated from both sides, shared by both cavities or may be two independent rear walls, e.g., a first gravitationally vertical wall that may be parallel with a second gravitationally vertical wall. Light rays are shown entering each cavity via its respective cavity and, in this example the common wall has a first surface of incidence 522 in the first cavity and a second surface of incidence 512 in the second cavity. Depending on the absorptivity of the first surface of incidence, a portion of the incident sunlight may be reflected to other surfaces within the cavity, the additional surfaces including the upper wall of each of the cavities 513,523 (and/or side walls of the cavity adjacent to the first surface or second surface. The geometry of the receiver may be designed to take into account the expected amount of internally-reflected sunlight. FIG. 6 illustrates in a perspective view a cavity solar receiver 600, having a portion of a working fluid circulating system, mounted on a post or tower. FIG. 7 illustrates an example of a tower-mounted multi-cavity solar receiver and steam turbine in a working fluid circulating system 700 mounted above a reflecting array.

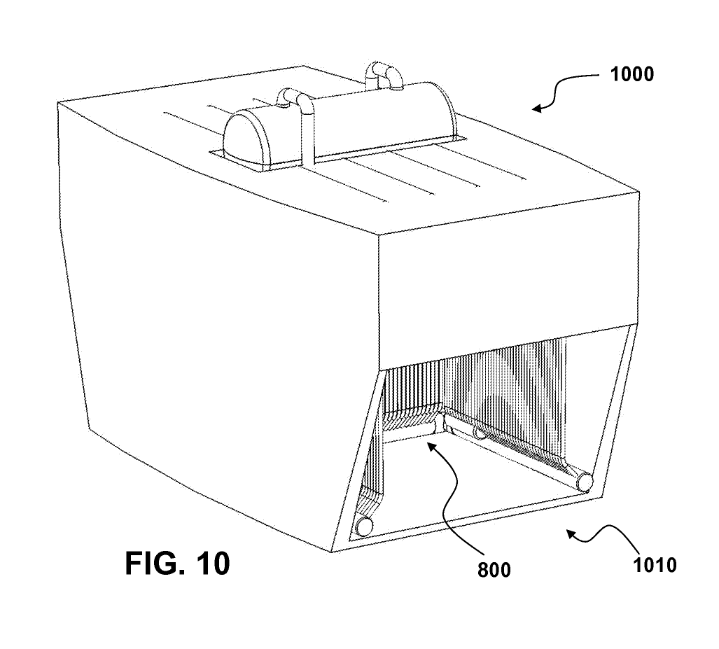

FIG. 8 illustrates a dual cavity solar receiver 800 in a top perspective view of the exemplary piping where the gravitationally vertical inner surfaces 851, 852 of the cavity are comprised of regions of tubing, piping and other plumbing to absorb concentrated sunlight. In portions of the tubing, water may boil and the boiling water may pass to the steam drum for steam separation. In other portions of the tubing, steam may be superheated and the superheated steam may pass to a release valve and thereafter may be conducted to a steam turbine. Water from the steam drum 810 is conducted to the lower evaporator headers 821 and the water transitions to steam within the plurality of evaporator tubes 823 to the upper evaporator headers 822. The tubes 823 collectively form a back wall 851 or panel and portions of the left and right side 852 walls or panels. The steam drum 810 receives water and steam from the evaporator headers 822 and the separated steam is vented 831 to superheater headers 832 and after superheating via absorbing heat from the tubes 833, the superheated steam may be sent to a steam turbine (not shown). Although the tubes 833 collectively form another portion of the left and side panels, the heat-absorbing tubes of the superheater may incorporated in some exemplary embodiments into a portion of the back panel 851 and/or a portion of the upper panel.

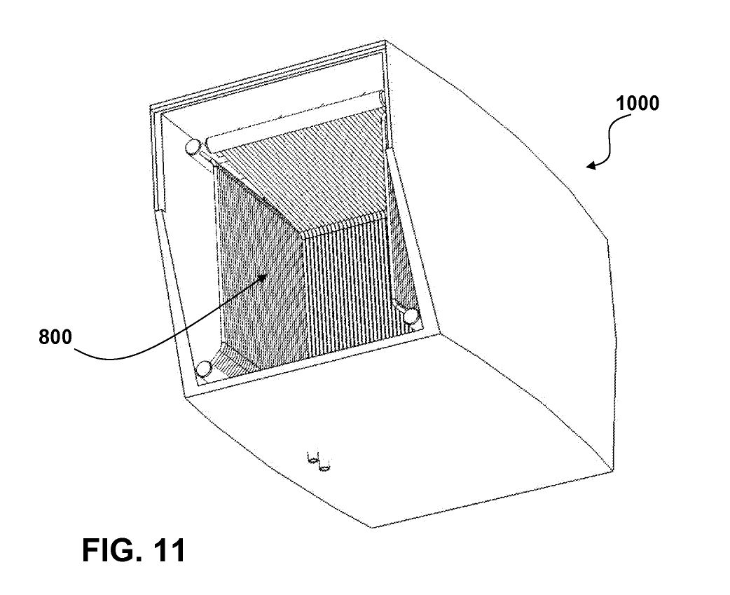

FIG. 9 illustrates a dual cavity solar receiver 800 in a bottom perspective view of the exemplary piping showing an exemplary cavity having four surfaces, i.e., two side surfaces 852, a top surface 953, and a back surface 851 of a panel or wall common with another cavity. The common wall maybe illuminated from both sides, resulting in greater thermal and mechanical stability, potentially increasing its service-free lifetime. One or more of these panels comprise the tubes 833 (in FIG. 8) in which water is converted to steam as the heat from the incident light is absorbed. As stated above, incident light may be received directly from one or more heliostats or indirectly from the heliostats by means of reflection from one or more different walls of the same cavity.

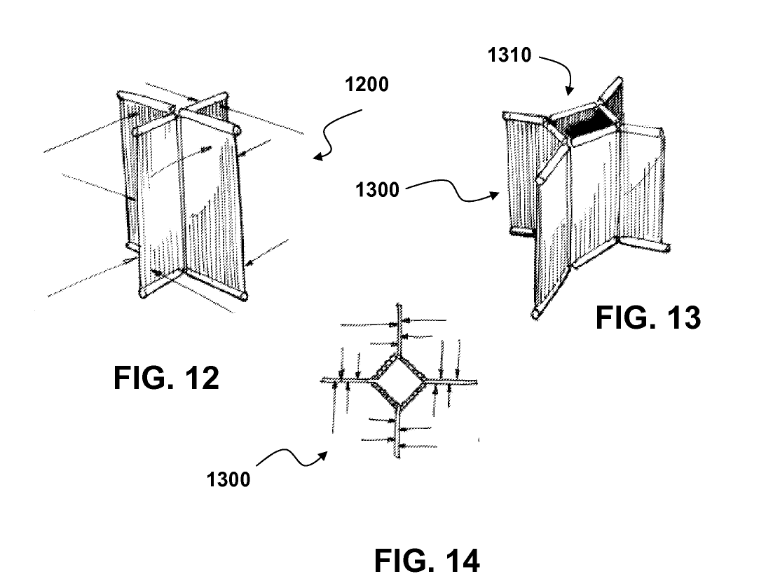

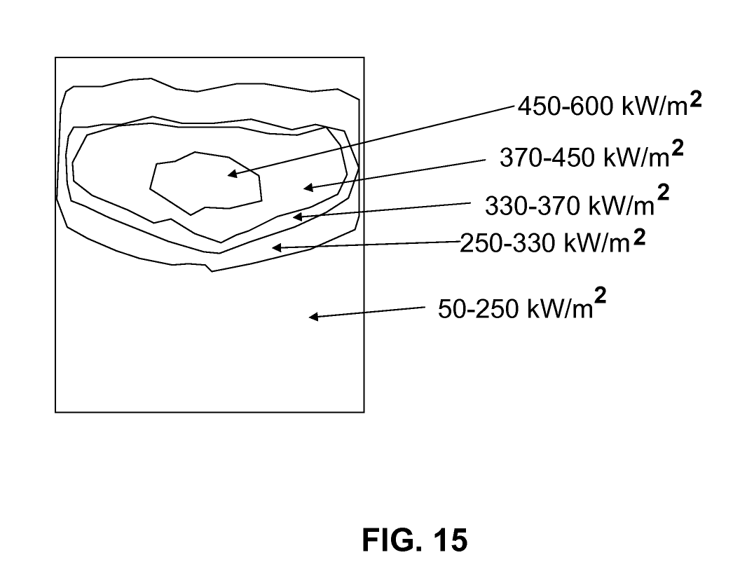

FIG. 10 illustrates in top perspective view a two-cavity, or dual cavity, receiver 800 having a housing 1000 about the receiver that may reduce convective and radiative losses and shield the solar flux absorptive walls from some weather and environmental effects. The receiver 800 accepts the solar radiation via apertures 1010. FIG. 11 illustrates in a bottom perspective view the two-cavity receiver 800 within the housing 1000.

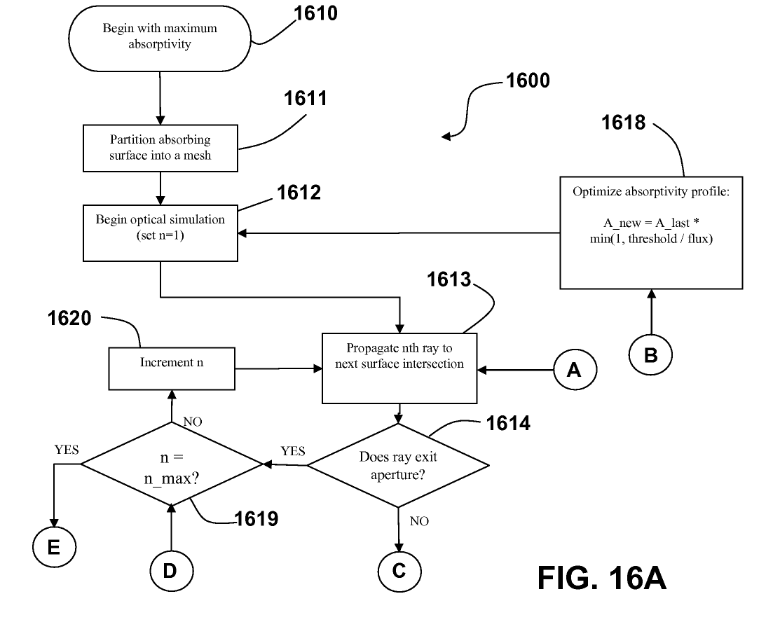

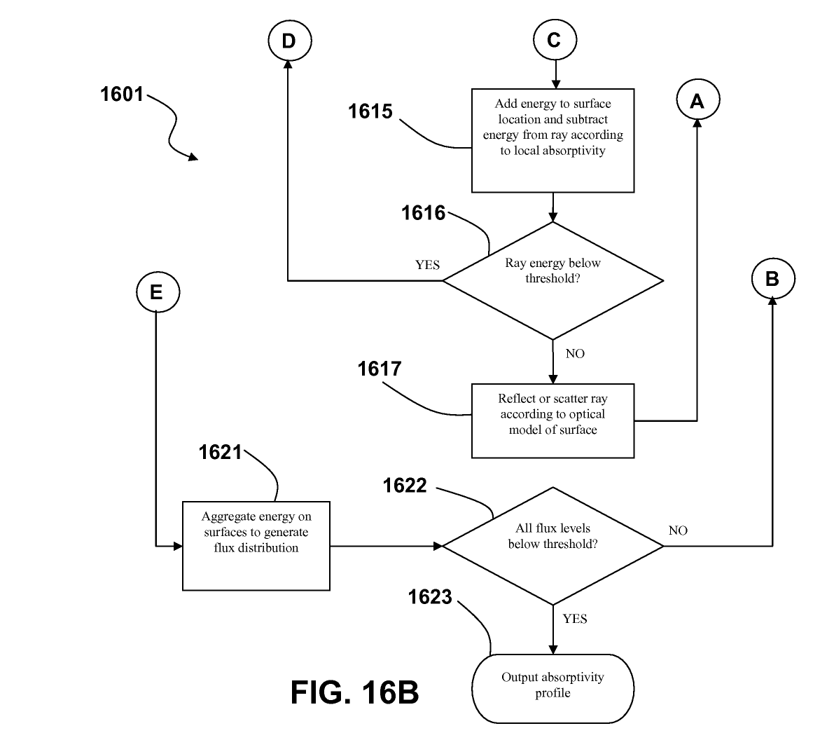

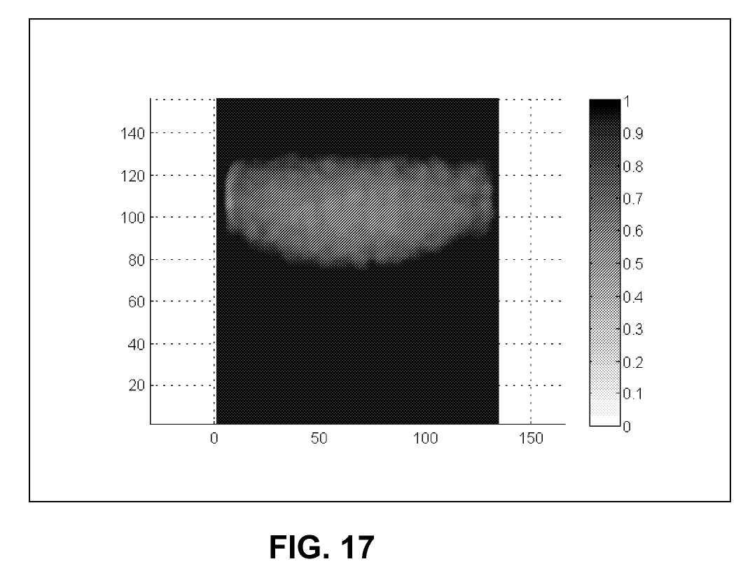

In addition to two-cavity receivers, multi-cavity solar receivers comprising three or more cavities may also be configured. For example, a receiver housing may have four apertures, each aperture accepting incoming sunlight into independent apertures, each associated with a corresponding cavity. The surfaces for absorbing the incident solar flux may be arranged, as in FIG. 12, where a four-panel receiver 1200 may be placed with a four-aperture housing and where an incident surface of one cavity and an incident surface of another cavity may be portions of a common panel. In another example, the surfaces for absorbing the incident solar flux may be arranged in external fashion, as in FIG. 13, where a central four-paneled structure 1300 has a panel extending from each of the four apexes of the four-paneled structure. In one embodiment, the four panels maybe formed out of two intersecting panels. The extending panels are shown where a left surface of one cavity and a right surface of another cavity may share a common panel. The channel 1310 formed by the four-paneled structure may be used for incoming liquid water and outgoing steam. The assembly may be housed within a four-aperture housing to create a four-cavity receiver. FIG. 14 shows a top view of the exemplary four-paneled structure 1300 having a panel extending from each of the four apexes of the four-paneled structure.

Having described exemplary solar receiver embodiments of the present invention, patterning of receiver walls in order to limit peak fluxes is now described. Patterning of receiver walls may result in a reduction of the absorptivity in some portions of the receiver and/or increase the absorptivity in some other portions of the receiver. For opaque materials, reflectivity is the complement of absorptivity, e.g., reflectivity=1.0−absorptivity. As mentioned above, flux non-uniformity at a receiver wall may generate hot spots, i.e., locations at which the flux is above a limit of safety. For example, a flux above 450 kW/m² is unacceptably high for certain types of carbon steel water tubes. A region of a first surface of incidence may comprise a flux so high that, if absorbed, the receiver working flow may be disrupted, e.g., by conduit or tube structural failure and by a boiling tube instead of flashing the boiling water entirely to steam at the volumes proximate to the surface of the conduit or tube. The inner surfaces of the solar receiver that receive the light rays directly from the reflective array may have light reflective material disposed on portions of the first surface to both reduce solar flux absorption at the first surface and redirect, via reflection, a portion of the incident solar flux to a second inner wall of the solar receiver (and so on, optionally from secondary wall to tertiary wall, and possibly other walls thereafter). Accordingly, reflective material or treatment, such as paint, a sputtered metal, or silicon carbide foam, may be applied to regions of the incident surface of a cavity receiver in order to reflect the incident light to one or more surfaces bounding a cavity of the receiver.

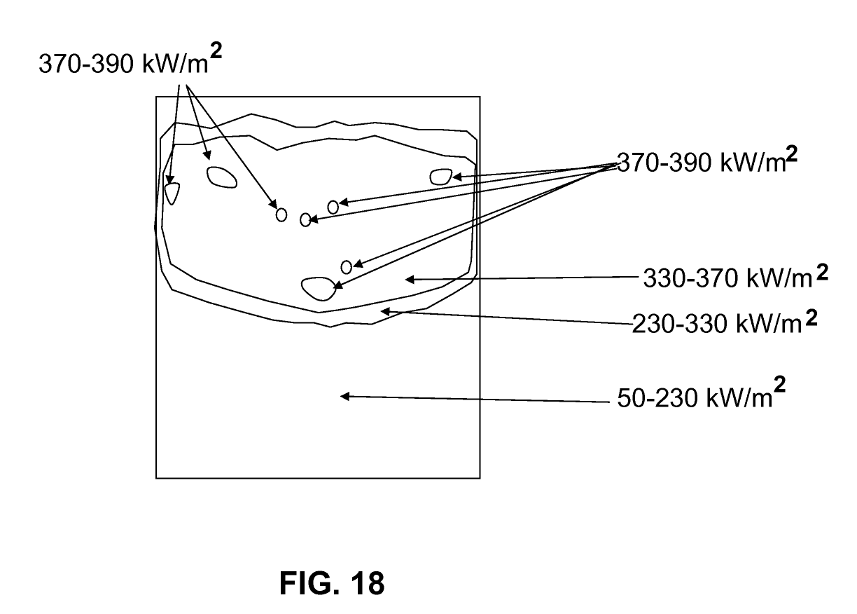

A reflectivity pattern for the absorbing surfaces of a solar receiver may be computed based on the desired absorptivity of a nominal absorptive surface of a receiver, the anticipated incident solar flux, and the absorptivity of regions of the receiver surface containing reflective patterns. For example, the reflectivity pattern may be generated to maintain peak absorbed heat fluxes below a determined threshold (e.g., between 400 and 600 kW/m²) that may be expected to keep the water tubes from failing in some embodiments. The reflectivity pattern may be generated to provide generally uniform absorptivity over the absorptive surface of one or more receiver panels. A surface of a cavity receiver may be painted with high-temperature black paint and have a surface solar flux absorptivity of 0.95, i.e., a reflectivity value of 0.05. An example of the flux distribution plot for one of the receiver absorbing surfaces in a cavity-type solar thermal receiver is shown in FIG. 15. Regions of FIG. 15 are shown having heat flux at 50-250 kW/m² and the heat flux may be as high as 600 kW/m².

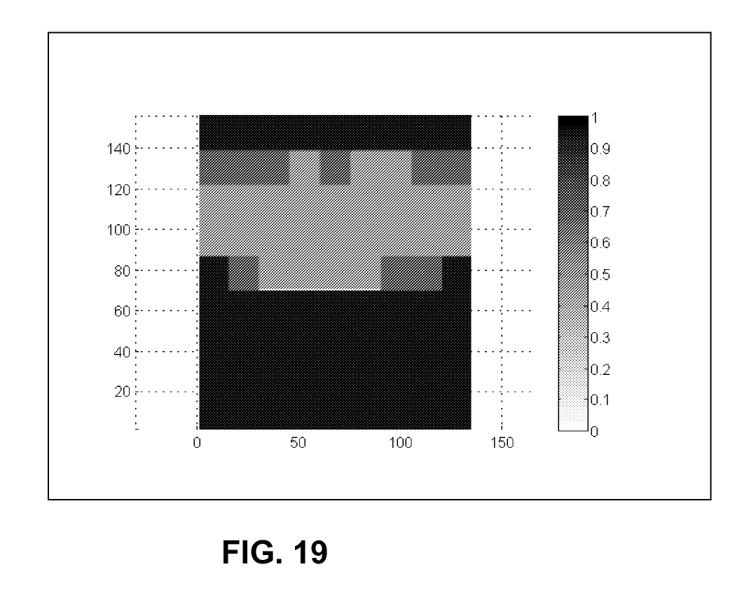

Operationally, in one carbon steel tubing embodiment with water as the HTF, it may be desirable to maintain the peak flux at a level below 450 kW/m². To accomplish this, a reflectivity pattern may be calculated and patterned onto the wall which, when effected by accounting both for incident solar flux and absorbed solar flux, works to reduce the heat absorption in those areas via added reflectivity. FIGS. 16A and 16B when combined comprise a flowchart, an upper portion 1600 and a lower portion 1601, of a method for calculating desired reflectivity patterns. The method applies ray-tracing techniques to generate an expected flux distribution, and may iterate over successively optimized reflectivity patterns. For example, the process of determining a reflectivity pattern for a cavity receiver having a sunlight-accepting aperture, e.g., as produced by a heliostat array) may initialize the entire pattern at low reflectivity (step 1610), e.g., a reflectivity value of 0.05 as produced by high-temperature black paint, to the target surface of a solar incidence. The absorbing surface may then be partitioned according to a grid or mesh (step 1611), also referred to as a “pattern.” Next, an iterative process of optical simulation may begin (step 1612) and a ray may be propagated to the next surface intersection (step 1613). If the ray does not exit the aperture of the cavity receiver (test 1614), then the next step (step 1615) adds energy to the surface location and subtracts energy from the ray according to local reflectivity. If the ray is at or above a threshold (test 1616), then the ray may be reflected or scattered according to the selected optical surface model (step 1617) and then the nth ray may be propagated to the next surface intersection (step 1613). If the ray is below the threshold (test 1616), then, if the max number of n rays is not achieved (test 1619), then the next ray, n, is incremented (step 1620), and the propagation step (step 1613) is invoked. If n rays have been propagated to n(max) (test 1619), a consistency check is made by aggregating energy on surfaces to generate flux distribution (step 1621). If all flux levels are below the flux threshold (test 1622), then the reflectivity pattern may be output (step 1623). But, if all the flux levels are not below the flux threshold (test 1622), then the process may optimize the reflectivity pattern (step 1618) according to a relationship, such as the new absorptivity coefficient which may be set as the last absorptivity coefficient scaled by the lesser of unity and the ratio of the threshold flux divided by the calculated flux; and the process restarts.

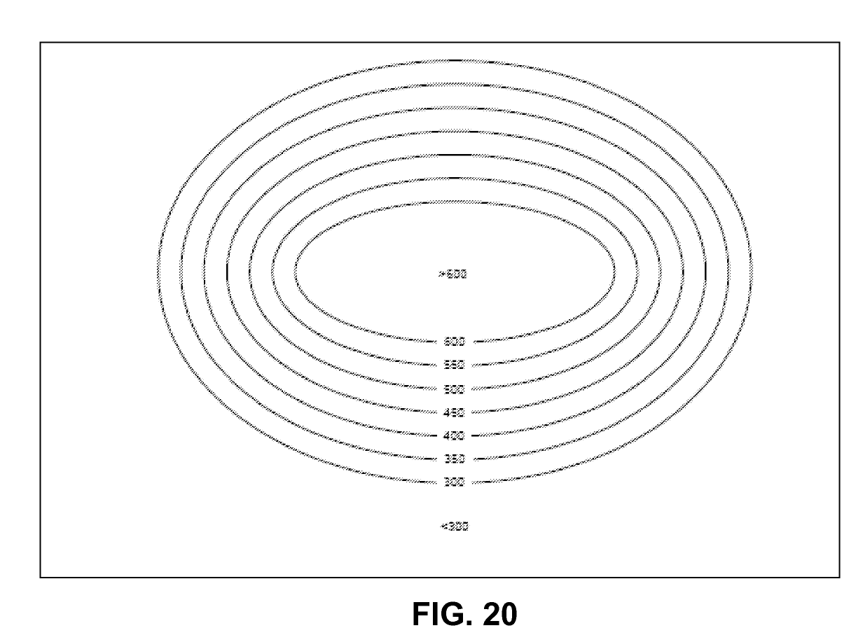

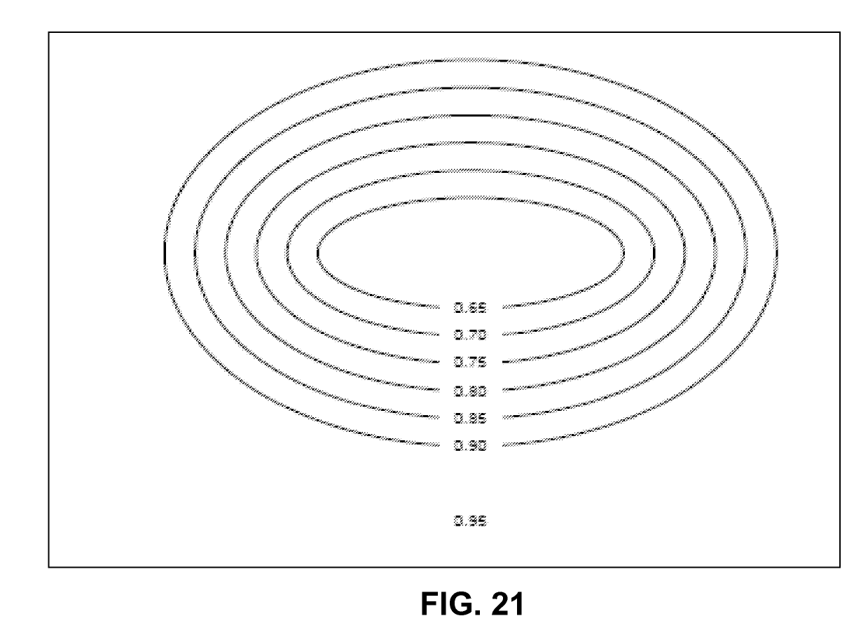

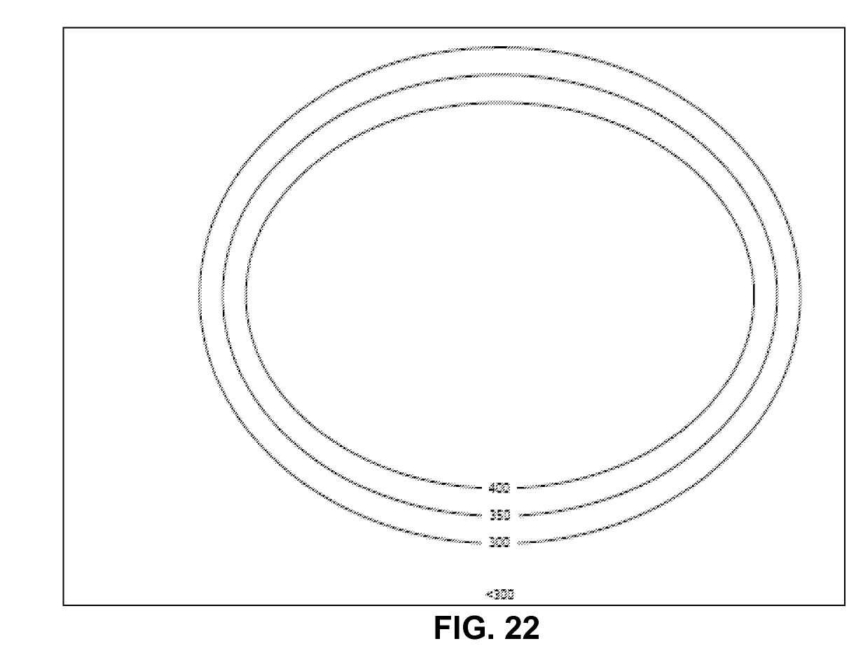

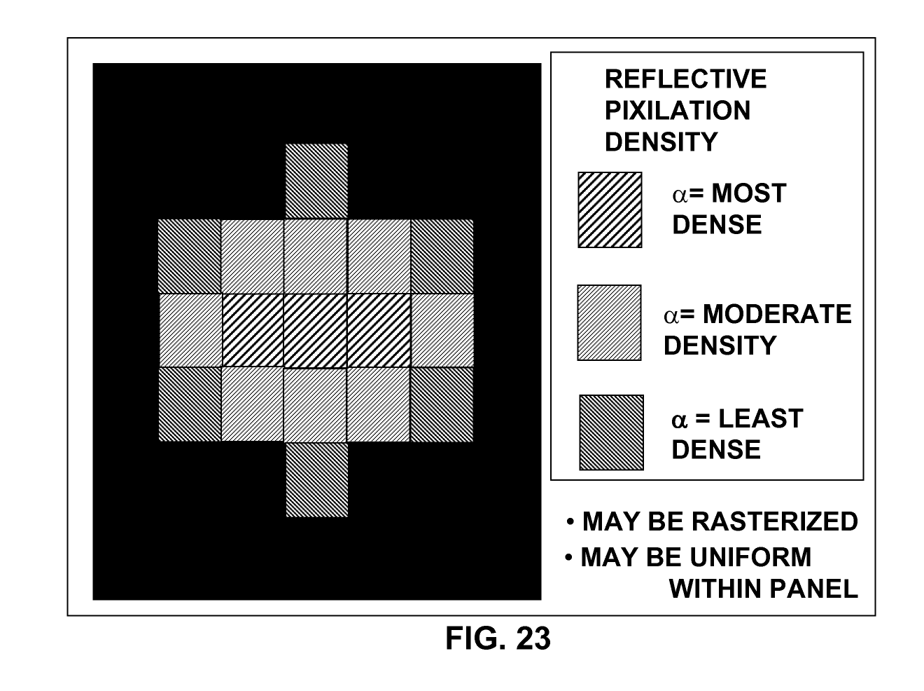

Applying the same incident solar energy to the receiver of FIG. 15 with the resulting reflectivity pattern of FIG. 17 yields the resulting heat flux pattern as shown in FIG. 18 where the peak flux density, in this example, held under 450 kW/m² and that the pattern is generally much more uniform across large regions of the surface. The reflectivity pattern of FIG. 17 may be simplified. One method of simplifying the application of the reflectivity pattern may be to partition the absorbing surface into a regularly spaced grid and paint each grid element, or panel of a panel array, with one shade of high-temperature paint or otherwise reduce or otherwise regulate the reflectivity of each grid element. The shade of paint may be white, black, or intermediate gray scale selected to enhance or reduce reflectivity of the surface and thereby achieve the desired absorptivity. The number of available shades, i.e., the quantization available, may be limited for reasons of practicality. An example of a pattern having three levels of absorptivity by the application of three different shades of paint, including black, is shown in FIG. 19. As can be seen, the paints are applied to a select receiver wall in a raster pattern that approximates the smoothly varying reflectivity pattern shown in FIG. 20. Optional patterns include pixilated panels, pixilated grayscale panels, and pixilated rasters.

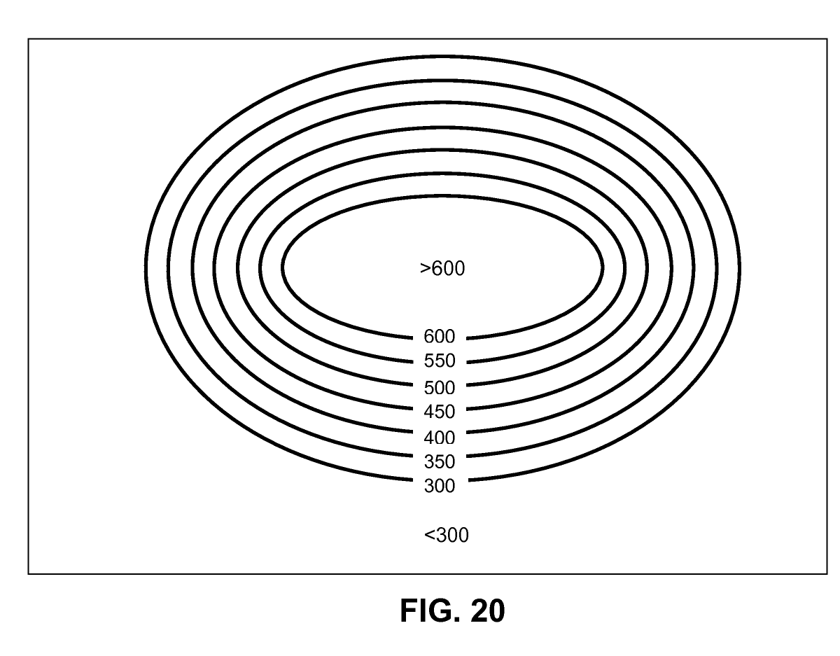

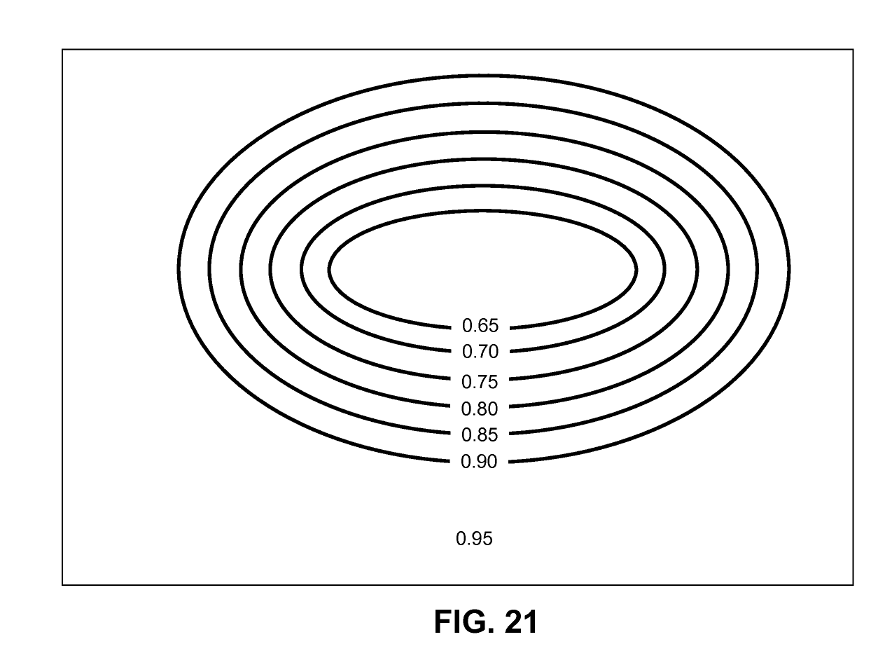

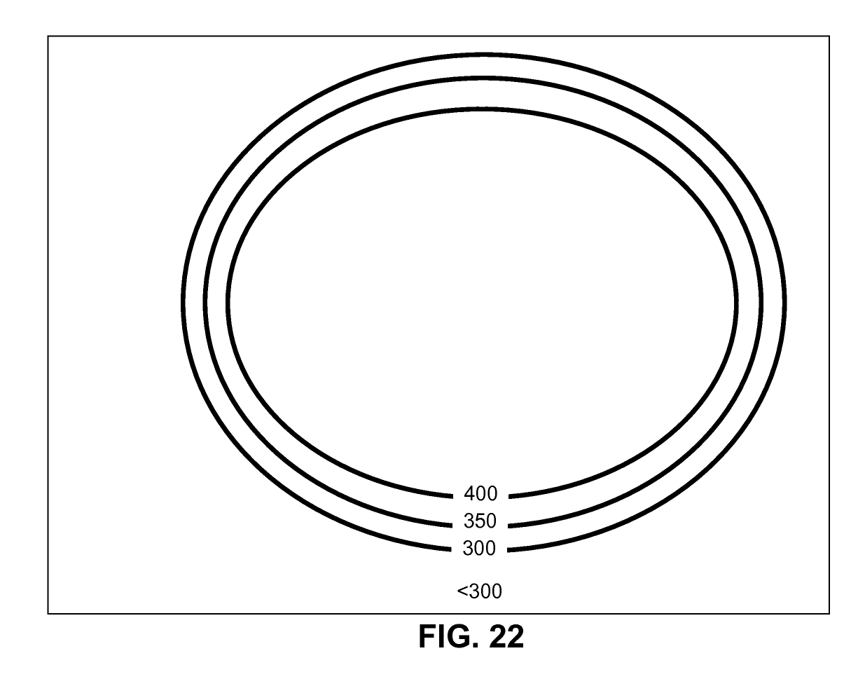

To explain the development of a reflectivity pattern further, an exemplary flux distribution for a rear wall of a cavity receiver painted black and having an absorptivity coefficient, α, of 0.95 (reflectivity of 0.05) is shown in FIG. 20 where units are in kW/m². It is generated according to the steps of the flowchart of FIGS. 16A and 16B having an objective of limiting peak flux to below 450 kW/m² as shown in FIG. 21 where the values shown are for the absorptivity coefficient, α. The resultant flux distribution for the rear wall of a cavity receiver painted with the reflectivity pattern of FIG. 21 is shown in FIG. 22 where units are in kW/m². An alternative reflectivity pattern for limiting the peak flux to below 450 kW/m² is shown in FIG. 23 where a few discrete levels of reflectivity may be applied and regions or panels are defined for the application of materials of particular reflectivity.

One of ordinary skill in the art will also appreciate that the elements and functions described herein may be further subdivided, combined, and/or varied and yet still be in the spirit of the embodiments of the invention. In addition, while a number of variations of the invention have been shown and described in detail, other modifications, which are within the scope of this invention, will be readily apparent to those of ordinary skill in the art based upon this disclosure, e.g., the exemplary flowcharts or processes described herein may be modified and varied and yet still be in the spirit of the invention. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A solar receiver comprising:
a receiver housing and comprising a cavity and an incident solar flux receiver comprising a first receiver panel, the first receiver panel comprising a plurality of boiler tubes.

2. The solar receiver of claim 1 wherein the first receiver panel comprises a first internal surface of the cavity comprising a light reflective material configured to reflect a portion of incident light received via a first housing aperture.

3. The solar receiver of claim 2 wherein the light reflective material comprises a paint.

4. The solar receiver of claim 2 wherein the light reflective material comprises a sputtered metal.

5. The solar receiver of claim 2 wherein the light reflective material comprises a silicon carbide foam.

6. The solar receiver of claim 2 wherein the light reflective material is applied in a non-uniform pattern.

7. The solar receiver of claim 2 wherein the light reflective material is applied in a non-uniform pattern comprising at least one of: pixilation, grayscale pixilation, and a panel array.

8. The solar receiver of claim 2 wherein the light reflective material is applied based on a non-uniform pattern to maintain flux absorptivity below the threshold.

9. The solar receiver of claim 2 wherein the light reflective material is applied in a non-uniform pattern to maintain flux absorptivity below the threshold; wherein the threshold is between 400-600 kW/m².

10. The solar receiver of claim 1 wherein the receiver housing comprising two cavities defined by the first housing aperture and a second housing aperture and the incident solar flux receiver, the incident solar flux receiver comprising a second internal surface for receiving incident light via the second housing aperture.

11. The solar receiver of claim 1 further comprising a boiler for receiving saturated steam and water from the first panel, the boiler comprising a steam separator and a steam conduit.

12. The solar receiver of claim 11 further comprising a second panel comprising a plurality of superheated steam tubes for receiving the separated steam.

13. A method of dispersing incident solar flux within a cavity of a solar receiver comprising:
determining a region of a cavity surface of the solar receiver exceeding a threshold of absorbed flux; and
applying a reflective material proximate to the determined region.

14. A method of claim 13 wherein the reflective material is selected from a group consisting of: paint, sputtered metal, and silicon carbide foam.

15. A method of dispersing incident solar flux within a cavity of a solar receiver comprising:
determining a region of a surface of a cavity wall of the solar receiver exceeding a threshold of absorbed flux; and
applying a reflective material proximate to a portion of the cavity wall surface based on the determined region exceeding the threshold.

16. A method of claim 15 wherein the reflective material is selected from a group consisting of: paint, sputtered metal, and silicon carbide foam.

17. A method of claim 15 wherein the step of applying the reflective material further comprises applying the reflective material non-uniformly across a portion of the wall of the receiver.

18. A method of claim 15 wherein the step of applying the reflective material further comprises applying the reflective material non-uniformly across a portion of the wall of the receiver based on a pattern comprising at least one of: pixilation, grayscale pixilation, and a panel array.

19. A method of claim 15 wherein the step of non-uniform application is based on maintaining flux absorptivity below the threshold.

20. A method of claim 15 wherein the step of non-uniform application is based on maintaining flux absorptivity below the threshold between 400-600 kW/m².
